(19) United States
(12) Patent Application Publication
(10) Pub. No.: US 2007/0006677 A1
(43) Pub. Date: Jan. 11, 2007

(54) Control handle for a public works vehicle

(75) Inventor: Xavier Roussin-Bouchard, La Murette (FR)

Correspondence Address: OLIFF & BERRIDGE, PLC, P.O. BOX 19928, ALEXANDRIA, VA, 22320, US

(73) Assignee: BOSCH REXROTH D.S.I., Venissieux (FR)

(21) Appl. No.: 10/570,029

(22) PCT Filed: Oct. 6, 2004
(86) PCT No.: PCT/FR04/02521

§ 371 Date: Mar. 1, 2006

(30) Foreign Application Priority Data
Oct. 14, 2003 (FR) 0311994

(51) Int. Cl. G05G 9/047

(52) U.S. Cl. 74/471 XY; 74/543; 200/522

(57) ABSTRACT

The invention relates to a control handle for a public works vehicle, comprising a core having an inner cavity. According to the invention, control elements are mounted to said core, said elements comprising buttons and/or sliding members which are intended to be actuated by an operator in order to enable the different functions of the vehicle to be controlled. In addition, at least part of the surface of the aforementioned core is covered with a casing comprising one layer of at least one low-pressure-cast thermosetting polymer foam.

The present invention relates to a control handle for a public works vehicle.

An increasing number of vehicles used in the field of construction and public works use remote control systems operated by means of ergonomic handles. These handles are designed to control not only electrohydraulic devices, but also other simpler functions such as lights or horns.

A handle is formed in a known way from two half-shells delimiting a cavity. These two half-shells are screwed or welded together. The handle is equipped with buttons and/or sliders to be operated by an operator for controlling various functions of the vehicle. The cavity provided between the two half-shells is used for the passage of the wires connecting the buttons or sliders to the elements to be controlled.

This type of handle gives rise to problems of sealing and strength. Furthermore, the feel of the material used is hard and disagreeable to the user. It is also difficult to customize handles, in other words to add certain optional components for esthetic or functional purposes, at reasonable cost. This is because the half-shells of known handles are made from synthetic material by injection of material under high pressure. This makes it necessary to use expensive steel molds, making it unfeasible to produce special molds for short production runs.

The object of the invention is to provide a control handle with a simple structure, which has an agreeable feel for the operator, and which can be customized as claimed in customers' requirements in respect of the appearance and the incorporation of a certain number of control elements, while retaining good mechanical characteristics, particularly in terms of rigidity.

For this purpose, the handle as claimed in the invention, comprising a core delimiting an internal cavity, on which are mounted control elements in the form of buttons and/or sliders to be activated by an operator for controlling various functions of the vehicle, is characterized in that at least part of the surface of the core is covered with a jacket consisting of a layer of at least one low pressure molded thermosetting polymer foam.

The overmolded jacket provides the handle with a soft feel, imparted by the material itself and by the texturing of the surface, if present. This is because the overmolded synthetic material, consisting of at least one expanded thermoplastic resin, is overmolded by a foaming method, and has a soft consistency.

Since this overmolding is carried out at low pressure, of the order of 4 to 5 bars for example, the molds used can be moderately priced because they can be made from aluminum or resin. Thus it is possible to produce handles with specific shapes for relatively limited production runs.

Furthermore, this jacket makes it possible to provide a perfect seal by eliminating the mating line between the two half-shells found in the conventional method.

Thus, after overmolding, the component becomes a single unit, the assembly screws are completely invisible, and the overmolding mating line is much finer than that created by the assembly of two pieces of synthetic material.

The synthetic material used is an expanded thermoplastic resin and is advantageously polyurethane. The jacket is overmolded in one piece on the core, and can cover the core entirely.

To impart sufficient mechanical strength to the handle, the core is made from a reinforced thermoplastic material.

To produce a sufficient depth of covering, the thickness of the foam jacket is ideally close to 4 mm, but this may be varied considerably.

As claimed in one characteristic of the invention, the overmolded jacket comprises at least one solid protruding part, for ergonomic reasons, for esthetic reasons relating to the customization of the handle, or for the mounting of at least one control element or an electromechanical or electronic component.

As claimed in another characteristic of the invention, the control elements such as buttons and/or sliders are mounted by clipping to the core, after the overmolding of the jacket, through apertures formed in the jacket. With this method, the handle cannot be dismantled and the operator is unable to access the components.

Advantageously, a heating cable is placed around the core before the latter is covered by the overmolded jacket.

The invention will be clearly understood with the aid of the following description, which refers to the attached schematic drawing which represents a number of embodiments of this handle in the form of non-restrictive examples.

FIG. 1 is a perspective view of the core of a handle equipped with a heating cable.

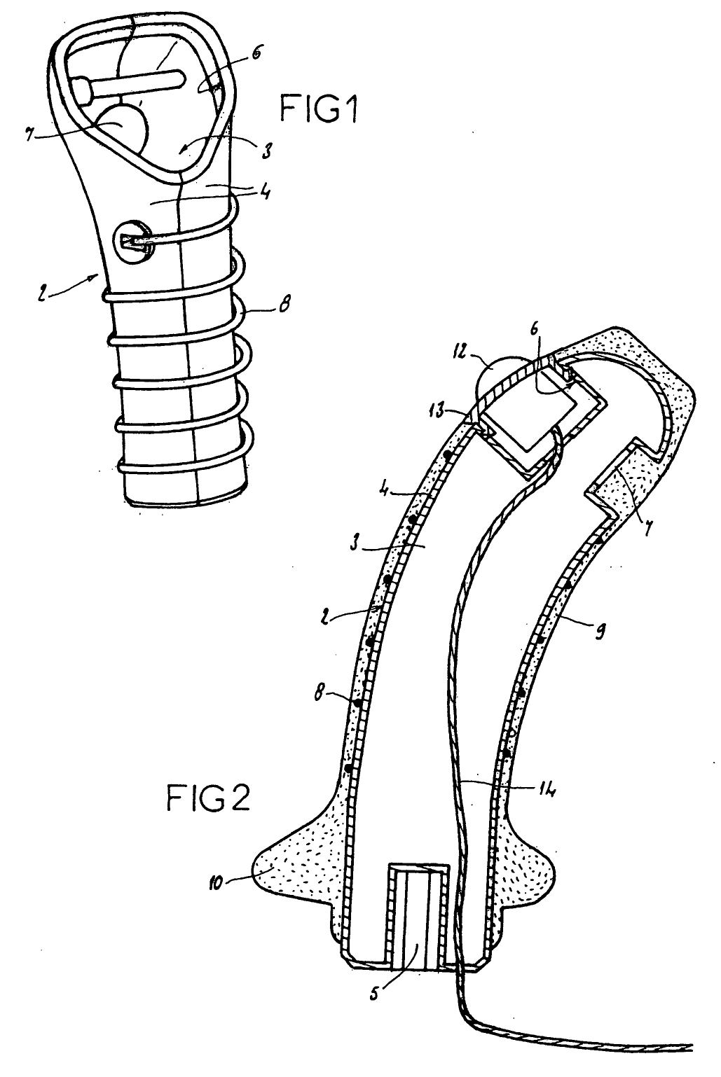

FIG. 2 is a view of the completed handle in longitudinal section.

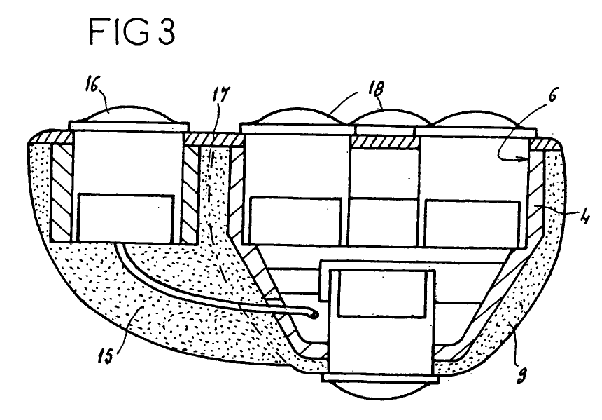

FIG. 3 is a view in longitudinal section of the upper part of another handle.

The handle as claimed in the invention comprises a core 2 delimiting an interior cavity 3, consisting of two half-shells 4 made from a reinforced thermoplastic material such as that known by the name PA 6-6. The two half-shells are fixed together in a known way, by screwing or welding. The lower end of the core 2 has a hexagonal recess 5 for fixing the handle to a support. The upper end of the recess has a main opening 6 and a secondary side opening 7.

In the embodiment shown in FIGS. 1 and 2, a heating cable 8 is wound on the outer surface of the core 2. This core 2 is covered with a jacket 9 made from polyurethane foam with a minimum thickness of 4 mm. This foam is deposited by a low pressure molding process inside a mold, the polyurethane being injected at low pressure into this mold before undergoing a foaming operation during polymerization. It may be noted that a collar 10 is produced at the base of the lever by means of the polyurethane alone, without the need for an insert. The rear opening 7, which is not used in this case, is covered by the polyurethane. In the front opening there is mounted at least one electronic component 12 associated with a support 13 which is clipped into the core 2. This mounting is irreversible, and provides an excellent seal for the interior of the core.

It should be noted that the polyurethane jacket completely covers the core, masking in particular the mating line of the two half-shells 4 of the core, and providing an excellent seal for the interior of the handle. Thus, in particular, the electromechanical components 12 and the electrical cable 14 to which these are connected are fully protected. In addition to this protective aspect, the polyurethane jacket imparts an agreeable feel to the handle for the operator, and can be used to produce solid forms which do not completely follow the shape of the core.

FIG. 3 shows how solid protruding parts can be made from polyurethane. FIG. 3 shows an upper end of a handle in which the same components are indicated by the same references as before. In this case, a solid protruding part 15 made from polyurethane foam extends beyond the core and serves to house a remote electromechanical component 16, which is associated with a plate 17 holding the other electromechanical components 18, in other words those which are associated with the main part of the lever and are housed inside the core.

As explained above, the invention greatly improves the prior art by providing a handle with a simple structure, having excellent mechanical characteristics, at a lower production cost, providing an excellent seal for the interior of the handle, and enabling the outer shape of the handle to be customized for both esthetic and functional or ergonomic reasons, or for mounting certain components, while providing the operator with a surface having an agreeable feel.

Clearly, the invention is not limited to the embodiments of this handle described above by way of example, but includes all variants of these. Thus, in particular, the number of solid areas of synthetic material could be different, and the material used could be not polyurethane, but another material having properties suitable for molding combined with foaming, without departure from the scope of the invention.

1. Control handle for a public works vehicle, comprising a core which delimits an interior cavity, on which are mounted control elements comprising buttons and/or sliders designed to be activated by an operator for controlling different functions of the vehicle, characterized in that at least part of the surface of the core is covered with a jacket consisting of a layer of at least one low pressure molded thermosetting polymer foam.

2. Control handle as claimed in claim 1, characterized in that the overmolded layer of synthetic material is made from polyurethane.

3. Control handle as claimed in claim 1, characterized in that the jacket is overmolded in one piece on to the core.

4. Control handle as claimed in claim 1, characterized in that the core is made from a reinforced thermoplastic material.

5. Control handle as claimed in claim 1, characterized in that the thickness of jacket is at least 4 mm.

6. Control handle as claimed in claim 1, characterized in that the overmolded jacket comprises at least one solid protruding part.

7. Control handle as claimed in claim 6, characterized in that at least one solid protruding part comprises at least one cavity used for mounting a control element or an electromechanical or electronic element.

8. Control handle as claimed in claim 1, characterized in that the control elements are mounted on the core by clipping, after the overmolding of the jacket.

9. Control handle as claimed in claim 1, characterized in that a heating cable is positioned around the core, before the latter is covered with the overmolded jacket.
